(19) United States
(12) Patent Application Publication
(10) Pub. No.: US 2025/0131578 A1
(43) Pub. Date: Apr. 24, 2025

(54) WAFER DEFECT DETECTION METHOD, DEVICE, ELECTRON-BEAM SCANNING DEVICE AND STORAGE MEDIUM

(71) Applicant: SwaySure Technology Co., Ltd., Shenzhen (CN)

(72) Inventor: Xiong ZHAO, Shenzhen (KR)

(21) Appl. No.: 18/811,508

(22) Filed: Aug. 21, 2024

(30) Foreign Application Priority Data
Oct. 24, 2023 (CN) 202311390935.0

(51) Int. Cl. G06T 7/44; G06T 7/143

(52) U.S. Cl. CPC G06T 7/44; G06T 7/143; G06T 2207/10061; G06T 2207/30148

(57) ABSTRACT

A wafer defect detection method, after initiating electron-beam scanning of a target defect detection region of a to-be-detected wafer, obtains a wafer image of the to-be-detected wafer, calculates the image sharpness of the wafer image, and obtains a sharpness evaluation value of the wafer image based on the image sharpness of the wafer image, and when the sharpness evaluation value fails to meet the preset condition, which indicates that the quality of the obtained wafer image is poor, marks the defect detection result of the to-be-detected wafer as unreliable detection result, for distinguishing the defect detection result of the to-be-detected wafer with a good quality of the wafer image, thereby improving the reliability of the defect detection result of each to-be-detected wafer, and avoiding the use of wrong defect detection results in subsequent processes.

### CROSS-REFERENCE TO RELATED APPLICATIONS

This application claims priority to Chinese Patent Application 202311390935.0, filed Oct. 24, 2023, the entire disclosure of which is incorporated herein by reference.

### TECHNICAL FIELD

The present application relates to the field of semiconductor technology, and particularly to a wafer defect detection method, a wafer defect detection device, an electron-beam scanning device and a storage medium.

### BACKGROUND

With the development of the semiconductor industry, an electron-beam scanning device is widely used in the semiconductor field for the detection of nanoscale physical defects in the wafer and turn on/off defects in the circuit. The quality of the wafer image is directly related to the defect detection results, but due to the basic principle of the electron-beam scanning device, it is impossible to achieve accurate stability of the wafer image, and it is difficult to ensure the quality of the wafer image.

At present, the industry's electron-beam scanning device rarely has an image quality monitoring system, resulting in wrong detection results of physical defects in the wafer and turn on/off defects in the circuit and defect detection results of low reliability because of poor image quality, which will lead to subsequent processes using the wrong defect detection results. Although some electron-beam scanning devices are provided with the image quality monitoring systems, but the image quality monitoring systems obtain sample images before scanning, and adjust the scanning device lens, the electron-beam, etc. based on the obtained sample image, to obtain a better quality of the wafer image during defect detection, which cannot ensure that the actual image quality will not lead to misdetection of defects and defect detection results of low reliability.

### SUMMARY

There are provided a wafer defect detection method, a wafer defect detection device, an electron-beam scanning device, and a computer-readable storage medium according to embodiments of the present application. The technical solution is as below:

According to a first aspect of embodiments of the present application, there is provided a wafer defect detection method is disclosed, the wafer defect detection method includes:
scanning, by an electron-beam, a target defect detection region of a to-be-detected wafer to detect a defect of the target defect detection region, the to-be-detected wafer has one or more defect detection regions;
obtaining a wafer image of the to-be-detected wafer, and calculating an image sharpness of the wafer image;
obtaining a sharpness evaluation value of the wafer image based on the image sharpness of the wafer image;
determining whether the sharpness evaluation value of the wafer image meets a preset condition; and
marking a defect detection result of the to-be-detected wafer as an unreliable detection result when the sharpness evaluation value of the wafer image fails to meet the preset condition.

According to a second aspect of the present application, there is provided a wafer defect detection device is disclosed, the wafer defect detection device includes:
a to-be-detected wafer scanning module, configured for scanning, by an electron-beam, a target defect detection region of a to-be-detected wafer to detect a defect of the target defect detection region, the to-be-detected wafer has one or more defect detection regions;
an image sharpness calculation module, configured for obtaining a wafer image of the to-be-detected wafer, and calculating an image sharpness of the wafer image;
a sharpness evaluation value calculation module, configured for obtaining a sharpness evaluation value of the wafer image based on the image sharpness of the wafer image;
a sharpness evaluation value determination module, configured for determining whether the sharpness evaluation value of the wafer image meets a preset condition; and
a detection result marking module, configured for marking a defect detection result of the to-be-detected wafer as an unreliable detection result when the sharpness evaluation value of the wafer image fails to meet the preset condition.

According to a third aspect of the present application, there is provided an electron-beam scanning device, the electron-beam scanning device includes:
one or more processors;
a memory, for storing one or more computer programs;
wherein the one or more computer programs, when executed by the one or more processors, cause the processors to implement the wafer defect detection method as mentioned above.

According to a fourth aspect of an embodiment of the present application, there is provided a computer-readable storage medium, on which computer-readable instructions are stored, the computer-readable instructions when executed by a processor of a computer, cause the computer to implement the wafer defect detection method as mentioned above.

It should be understood that the above general description and the later detailed description are only exemplary and do not limit the present application.

### BRIEF DESCRIPTION OF THE DRAWINGS

The accompanying drawings herein, which are incorporated into and form a part of the specification, illustrate embodiments in compliance with the present application and are used together with the specification to explain the principles of the present application.

FIG. 1 is a schematic diagram of detection results corresponding to a poor image quality and a good image quality of an embodiment.

FIG. 2 is a flowchart of a wafer defect detection method of an embodiment of the present application.

FIG. 3 is a flowchart of quality detection step of a brightness and contrast image of an embodiment of the present application.

FIG. 4 is a schematic diagram of a gray scale distribution and a standard gray scale distribution obtained by an embodiment of the present application.

FIG. 5 is a flowchart of quality detection step of the astigmation image of an embodiment of the present application.

FIG. 6 is a flowchart of quality detection step of a focus image of an embodiment of the present application.

FIG. 7 is an overall flowchart of detecting the defect of the wafer of an embodiment of the present application.

FIG. 8 is a compositional block diagram of a wafer defect detection device of an embodiment of the present application.

FIG. 9 is a compositional block diagram of an electron-beam scanning device of an embodiment of the present application.

FIG. 10 is a structural block diagram of a computer system for implementing some embodiments of the present application.

### DETAILED DESCRIPTION OF THE EMBODIMENTS

Embodiments will now be described more fully with reference to the accompanying drawings. However, the embodiments can be implemented in a variety of forms and should not be construed as a limitation to the examples set forth herein; rather, the provision of these embodiments makes the description of the present application more comprehensive and complete and conveys the idea of the embodiments to those skilled in the art in a comprehensive manner.

The terms “first”, “second”, and “third” are used for descriptive purposes only and are not to be construed as indicating or implying relative importance or implicitly specifying the number of technical features indicated. The number of technical features indicated is not to be understood. As a result, a feature defined as “first”, “second”, or “third” may explicitly or implicitly include one or more features.

In addition, the described features, structures, or characteristics may be combined in one or more embodiments in any suitable manner. In the following description, many specific details are provided thereby giving a full understanding of the embodiments of the present application. However, those skilled in the art will realize that it is possible to practice the technical embodiments of the present application without one or more of the specific details, or that other methods, components, devices, steps, etc. may be employed. In other instances, publicly known methods, devices, implementations, or operations are not shown or described in detail to avoid blurring aspects of the present application.

The flowcharts shown in the accompanying drawings are merely exemplary illustrations and are not required to include all elements and operations/steps, nor are they required to be performed in the order depicted. For example, some of the operations/steps may also be decomposed, and some of the operations/steps may be combined or partially combined, so that the actual order of execution may change depending on the actual situation.

Electron-Beam Inspection (EBI), which uses information excited by high-energy electrons interacting with substances on the wafer surface for imaging, and achieves the purpose of detecting electrical and physical defects on the wafer through image processing and arithmetic, is a key device for yield improvement in the chip manufacturing process. The image quality of imaging is directly related to the defect detection results, when the image quality is poor, it will lead to defect detection results of low reliability.

Some existing EBIs do not monitor the image quality during the E-beam scanning of the to-be-detected wafer. In general, there is a probability of image quality drift less than 1% in the recipe, mainly due to image focus, image brightness or image contrast, and astigmation capture failures, and also sudden death of the device's own hardware. The effects brought by the image quality drift are that defects are not detected during the detection process, and there is currently no early warning mechanism, thereby resulting in that defect detection departments cannot ensure the reliability of defect detection results.

Although some existing EBIs are provided with the image quality monitoring systems, but the image quality monitoring systems obtain microchip images pre-embedded by EBI machine before the E-beam scanning is performed, and adjust the scanning device lens, the electron-beam, etc. based on the obtained sample image, to obtain a better quality of the wafer image during defect detection, which cannot ensure that sufficient good quality will not lead to misdetection of defects, and the quality of the sample image does not accurately represent the actual image quality of the to-be-detected wafer. In some cases, for example, the thickness of the to-be-detected wafer is different from the thickness of the sample wafer, there may be a good quality of the sample image, but the actual image quality of the to-be-detected wafer is not good, which also leads to defect detection results of low reliability, thereby leading to the use of wrong defect detection results in subsequent processes.

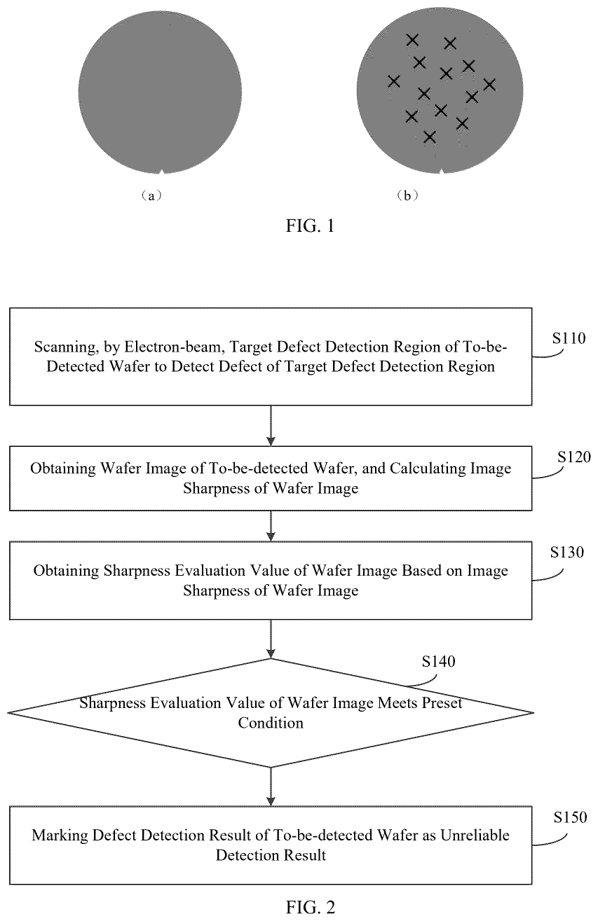

Exemplarily, the to-be-detected wafer actually has defects, but due to the poor quality of the wafer image obtained during the defect detection, no defect is detected, thus the defect detection result of the to-be-detected wafer is 0 defect, as shown in (a) in FIG. 1. While when the wafer image obtained during the defect detection has good quality, the defect detection result of the to-be-detected wafer is that a number of grain crystals have defects, marked by x, as shown in (b) in FIG. 1.

As the critical dimension (CD) of a semiconductor device is shrinking gradually and detection results required for the industry become more strict gradually, the reliability of defect detection results become more important gradually. Thus the present application provides a wafer defect detection method that obtains a wafer image of a to-be-detected wafer after initiating an electron-beam scanning of a target defect detection region of the to-be-detected wafer, analyses the wafer image to determine the quality of the wafer image, and marks the defect detection result of the to-be-detected wafer as an unreliable detection result when determining that the quality of the wafer image is poor, for distinguishing the defect detection result of the to-be-detected wafer that has a good quality of the wafer image, thereby improving the reliability of the defect detection result of each to-be-detected wafer, which can avoid the use of wrong defect detection results in subsequent processes.

The wafer defect detection method provided in the present application is described in detail below in conjunction with specific implementations.

FIG. 2 is a flowchart of a wafer defect detection method of an embodiment of the present application. Referring to FIG. 2, the wafer defect detection method includes at least a wafer defect detection step, an image acquisition and sharpness calculation step, a sharpness evaluation value acquisition step, an image quality determination step, a detection result marking step, etc., respectively, corresponding to the following steps S110 to step S150, as described in detail below:

Step S110, scanning, by an electron-beam, a target defect detection region of a to-be-detected wafer to detect a defect of the target defect detection region.

The to-be-detected wafer has one or more defect detection regions. When the to-be-detected wafer has only one defect detection region, the target defect detection region is the defect detection region. When the to-be-detected wafer has a plurality of defect detection regions, the target defect detection region may be one of the plurality of defect detection regions, or may be two or more of the plurality of defect detection regions. Exemplarily, the to-be-detected wafer has a plurality of defect detection regions, and the plurality of defect detection regions are located in an upper-left corner region, an upper-right corner region, a lower-left corner region, a lower-right corner region of the to-be-detected wafer, respectively. In one embodiment, the target defect detection region includes the upper-left corner region and the upper-right corner region. In another embodiment, the target defect detection region includes the lower-left corner region and the lower-right corner region.

It is to be understood that the target defect detection region is a defect detection region where needs to be scanned by the electron-beam currently to detect a defect. When the to-be-detected wafer has the plurality of defect detection regions, the plurality of defect detection regions can be scanned by the electron-beam intermittently and the scanning of the plurality of defect detection regions can be divided into many times of scanning, for example, first the upper-left corner region and the upper-right corner region are taken as the target defect detection region to be scanned by the electron-beam, and then after the upper-left region and the upper-right region are scanned completely, then the lower-left corner region and the lower-right region are taken as the target defect detection region to be scanned by the electron-beam. In this case, other steps may be inserted between two electron-beam scannings, such as the following steps S120 to S140. Of course, when the to-be-detected wafer has the plurality of defect detection regions, the plurality of defect detection regions can be scanned by the electron-beam at one time, that is, other steps cannot be inserted before all the defect detection regions of the to-be-detected wafer are scanned completely by the electron-beam.

In an embodiment, the detection of defects in the target defect detection region is that in the scanned image obtained by scanning the target defect detection region of the to-be-detected wafer by the electron-beam, gray scales of any two of three adjacent grain crystals inside the wafer are subtracted, i.e. by comparison of any two grain crystals, to find one grain crystal different from other two grain crystals among the three grains as an existing defective grain. Such method has a high accuracy of the defect detection results.

Step S120, obtaining a wafer image of the to-be-detected wafer, and calculating an image sharpness of the wafer image.

In one embodiment, after scanning of the target defect detection region of the to-be-detected wafer by the electron-beam is finished, the to-be-detected wafer whose the target defect detection region has been scanned is scanned by the electron-beam to obtain a wafer image. After the scanning of the target defect detection region is finished, the wafer image is then obtained, such that the technology has a low difficulty and is easily implemented. In other embodiments, the wafer image may also be obtained in real-time during the electron-beam scanning of the target defect detection region of the to-be-detected wafer.

The wafer image is not specifically an image that covers all regions of the to-be-detected wafer, but may be an image of a local region of the to-be-detected wafer. In one embodiment, the obtained wafer image is an image of a wafer region that is located outside the target defect detection region on the to-be-detected wafer, has a distance from the target defect detection region less than a first preset distance, and is not scanned by the electron-beam. As there are traces left on the wafer region scanned by the electron-beam, affecting the image quality, thus it obtains an image of the wafer region close to the target defect detection region and not scanned by the electron-beam, the image quality of the wafer image obtained is more representative of the actual image quality of the target defect detection region in the scanning process, thereby making the processing results of the subsequent steps more accurate.

The first preset distance is a preset distance sufficiently close to the target defect detection region, so that the wafer image is an image of a region adjacent to the target defect detection region, to avoid that the obtained wafer image cannot accurately represent the image quality of the target defect detection region in the scanning process due to subtle errors among different regions of the to-be-detected wafer.

In an embodiment, the image sharpness of the wafer image is calculated based on a formula

$$P = \frac{{\sum }_{i = 1}^{m \times n} {\sum }_{a = 1}^{8} \vert df / dx \vert}{m \times n} ,$$

P is the image sharpness of the wafer image, m and n are a length and a width of the wafer image, respectively, and df is a magnitude of gray scale change of a pixel point of the wafer image, dx is a distance increment between pixel points of the wafer image, i is a pixel point of the wafer image, and a is a neighbor point of the pixel point. That is, the gray scales of 8 neighbor points of each pixel point in the wafer image are taken to be subtracted with the gray scales of the pixel point one by one, respectively, and it firstly solves the weighted sum of 8 gray scale difference values df obtained after subtracting the gray scales of 8 neighbor points with the gray scales of the pixel point respectively. The weight depends on the distance dx between the neighbor points and the pixel point, and the closer the neighbor point to the pixel point, the bigger the weight of the neighbor point, and the further the neighbor point away from the pixel point, the smaller the weight of the neighbor point. For example, a weight of the gray scale difference value between the gray scale of 45° and the gray scale of 135° is equal to a weight obtained by multiplying the weight of the gray scale difference value between the gray scale of 0° and the gray scale of 90° by 1/\sqrt{2}; and then the values of all pixel points are summed up and divided by the total number m×n of pixel points of the wafer image, to obtain the image sharpness of the wafer image P. The formula can be regarded as a statistic for the diffusion degree of gray scales around each pixel point of the wafer image, that is, the more intense the diffusion is, the larger the value is, and the sharper the image is.

In this embodiment, the gray scale distribution of the image is reflected by the sum of gray scale difference values of the 8 neighbor points of the wafer image, which is not susceptible to fluctuations in parameters caused by factors such as noise, such that accurate image sharpness calculation results can be obtained. Of course, in other embodiments, the image sharpness of the wafer image can also be calculated in other ways.

Step S130, obtaining a sharpness evaluation value of the wafer image based on the image sharpness of the wafer image.

The sharpness evaluation value is a parameter that can be used to evaluate a good or poor quality of the wafer image and is associated with the image sharpness of the wafer image.

In an embodiment, the sharpness evaluation value of the wafer image is obtained based on the image sharpness of the wafer image, that is, the sharpness evaluation value of the wafer image is obtained by calculating a sharpness difference value between the image sharpness of the wafer image and a preset standard sharpness of the wafer image, that is, a sharpness difference value between the image sharpness of the wafer image and a preset standard sharpness of the wafer image is taken as the sharpness evaluation value of the wafer image. The method of calculating the sharpness evaluation value of the wafer image is simple and can accurately evaluate the image quality of the wafer image.

In an embodiment, the sharpness evaluation value of the wafer image is obtained based on the image sharpness of the wafer image, that is, the image sharpness of the wafer image is used as the sharpness evaluation value of the wafer image. When the sharpness evaluation value of the wafer image is greater than or equal to the sum of the preset standard sharpness of the wafer image and the first sharpness difference threshold, the sharpness evaluation value of the wafer image fails to meet the preset condition.

Of course, the present application is not limited to taking the sharpness difference value between the image sharpness of the wafer image and the preset standard sharpness of the wafer image, or the image sharpness of the wafer image as the sharpness evaluation value of the wafer image. In other embodiments, the sharpness evaluation value of the wafer image can be determined in an arbitrary manner.

Step S140, determining whether the sharpness evaluation value of the wafer image meets a preset condition, when the sharpness evaluation value of the wafer image fails to meet the preset condition, step S150 is entered.

In the embodiment where the sharpness difference value between the image sharpness of the wafer image and the preset standard sharpness of the wafer image is used as the sharpness evaluation value of the wafer image, when the sharpness evaluation value of the wafer image is greater than or equal to the first sharpness difference threshold, that is, the sharpness evaluation value of the wafer image fails to meet the preset condition, the step S150 is then entered. When the sharpness evaluation value of the wafer image is less than the first sharpness difference threshold, that is, the sharpness evaluation value of the wafer image meets the preset condition.

In the embodiment where the image sharpness of the wafer image is taken as the sharpness evaluation value of the wafer image, when the sharpness evaluation value of the wafer image is greater than or equal to the sum of the preset standard sharpness of the wafer image and the first sharpness difference threshold, that is, the sharpness evaluation value of the wafer image fails to meet the preset condition, and step S150 is entered. When the sharpness evaluation value of the wafer image is smaller than the sum of the preset standard sharpness of the wafer image and the first sharpness difference threshold, that is, the sharpness evaluation value of the wafer image meets the preset condition.

Step S150, marking a defect detection result of the to-be-detected wafer as an unreliable detection result.

The sharpness evaluation value of the wafer image fails to meet the preset condition, that is, the quality of the wafer image is poor. When determining that the quality of the wafer image is poor, the defect detection result of the to-be-detected wafer is marked as an unreliable detection result, which can be distinguished from the defect detection result of the to-be-detected wafer that has a good quality of the wafer image, so that the defect detection department can know whether the defect detection result of each to-be-detected wafer is reliable, which improves the reliability of the defect detection result of the to-be-detected wafer, and can avoid the use of wrong defect detection results in subsequent processes.

Optionally, in some embodiments, when step S140 determines that the sharpness evaluation value of the wafer image meets the preset condition, that is, the quality of the wafer image is good, the step of marking the defect detection result of the to-be-detected wafer as the reliable detection result may also be further performed, that is, in these embodiments, the defect detection results corresponding to the to-be-detected wafers that have poor quality of the wafer image and good quality of the wafer image are marked, to distinguish whether the defect detection result of each to-be-detected wafer is reliable.

The defect detection result of the to-be-detected wafer is marked as the unreliable detection result. The to-be-detected wafer can be directly marked by marking the wafer ID of the to-be-detected wafer, or can be indirectly marked by marking the serial number of the to-be-detected wafer in the corresponding wafer batch, that is, which piece of the wafer is in a certain wafer batch, at this time, there is no need to obtain the wafer ID of the to-be-detected wafer, the procedure is more simple.

In an embodiment, when the image quality determination step determines that the sharpness evaluation value of the wafer image fails to meet the preset condition, the defect detection stopping step is further performed, which includes stopping to detect the defect of the to-be-detected wafer.

When the to-be-detected wafer has the plurality of defect detection regions, and the target defect detection region does not contain all defect detection regions of the to-be-detected wafer, after the image quality determination step is performed, there may still be some to-be-detected defect detection regions. When there is a to-be-detected defect detection region in the to-be-detected wafer, the defect of the to-be-detected wafer is stopped to be detected, the defect detection process of the to-be-detected wafer that has a poor quality of the wafer image can be stopped timely, thereby avoiding meaningless execution steps and improving the effective utilization rate of the EBI.

Stopping to detect the defect of the to-be-detected wafer may be performed by outputting a control instruction for stopping the defect detection procedure of the to-be-detected wafer, so that the machine stops to detect the defect of the to-be-detected wafer based on the control instruction. In this embodiment, when the image quality determination step determines that the sharpness evaluation value of the wafer image fails to meet the preset condition, the defect detection stopping step is performed directly, such that the efficiency is high.

After the image quality determination step is performed, the to-be-detected wafer may also have no to-be-detected defect detection region. In some embodiments, when the image quality determination step determines that the sharpness evaluation value of the wafer image fails to meet the preset condition, it may also be possible to first perform the to-be-detected determination step, that is, to determine whether there is the to-be-detected defect detection region in the to-be-detected wafer. When there is the to-be-detected wafer in the to-be-detected defect detection region, then further the defect detection stopping step is performed to stop detecting the defect of the to-be-detected wafer.

In an embodiment, the image quality determination step and the detection result marking step are performed by the statistical process control (SPC) system, and after the sharpness evaluation value acquisition step is performed, a sharpness evaluation value output step is further performed to output the sharpness evaluation value of the wafer image to the SPC system. Afterwards, the SPC system performs the image quality determination step to determine whether the sharpness evaluation value of the wafer image meets the preset condition, and performs the detection result marking step to mark the defect detection result of the to-be-detected wafer as the unreliable detection result when the sharpness evaluation value of the wafer image is determined to not meet the preset condition.

In an embodiment where the wafer defect detection method includes a defect detection stopping step, the SPC system also performs the defect detection stopping step, that is, further performs a step of stopping to detect the defect of the to-be-detected wafer when the sharpness evaluation value of the wafer image fails to meet the preset condition.

In summary, the present application, after initiating electron-beam scanning of the target defect detection region of the to-be-detected wafer, obtains the wafer image of the to-be-detected wafer, calculates the image sharpness of the wafer image, and obtains the sharpness evaluation value of the wafer image based on the image sharpness of the wafer image, and when the sharpness evaluation value fails to meet the preset condition, which indicates that the quality of the obtained wafer image is poor, and marks the defect detection result of the to-be-detected wafer as the unreliable detection result, for distinguishing the defect detection result of the to-be-detected wafer that has a good quality of the wafer image, thereby improving the reliability of the defect detection result of each to-be-detected wafer, and avoiding the use of wrong defect detection results in subsequent processes. Moreover, it is stopped to detect the defect of the to-be-detected wafer when the sharpness evaluation value fails to meet the preset condition, such that the defect detection procedure of the to-be-detected wafer that has a poor quality of the wafer image can be stopped timely, thereby avoiding meaningless detection and improving the effective utilization rate of the EBI.

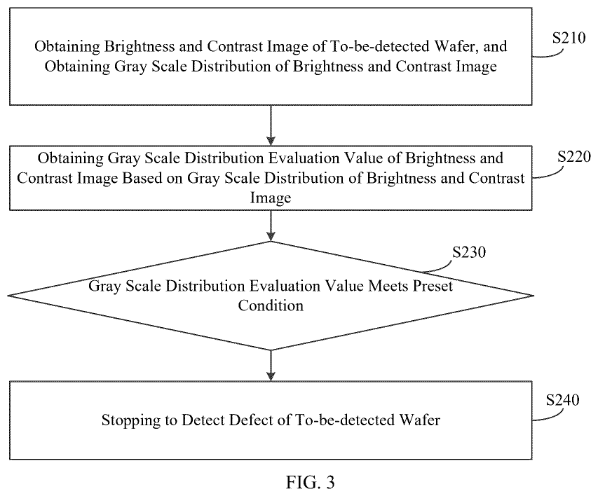

In some embodiments, before performing the wafer defect detection step, a brightness and contrast image quality detection step is performed, as shown in FIG. 3. the brightness and contrast image quality detection step includes a brightness and contrast image acquisition and gray scale distribution calculation step, a gray scale distribution evaluation value acquisition step, and a brightness and contrast image quality determination step, which correspond to the following steps S210 to step S230, respectively, as described in detail below:

Step S210, obtaining a brightness and contrast image of the to-be-detected wafer, and obtaining a gray scale distribution of the brightness and contrast image.

In an embodiment, obtaining the brightness and contrast image of the to-be-detected wafer includes: using the electron-beam to scan a wafer region that is located located outside the target defect detection region, has a distance from the target defect detection region less than a second preset distance, and is not the defect detection region, to obtain a brightness and contrast image of the wafer region.

The second preset distance is a preset distance sufficiently close to the target defect detection region, so that the brightness and contrast image is an image of a region adjacent to the target defect detection region, to avoid that the brightness and contrast image obtained cannot accurately represent the image quality of the target defect detection region due to subtle errors among different regions of the to-be-detected wafer.

In an embodiment, obtaining the gray scale distribution of the brightness and contrast image includes: obtaining a normal distribution of a number of pixel points corresponding to each gray scale in the brightness and contrast image; and calculating a number of pixel points corresponding to each gray scale within a preset number of sigmas in the normal distribution, to obtain the gray scale distribution of the brightness and contrast image. The statistical theory is that as long as the number of samples is large enough, the normal distribution will be presented, and this embodiment uses the statistical theory to calculate the gray scale distribution of the brightness and contrast image, which can accurately obtain the gray scale distribution of the brightness and contrast image.

Step S220, obtaining the gray scale distribution evaluation value of the brightness and contrast image based on the gray scale distribution of the brightness and contrast image.

The gray scale distribution evaluation value refers to a parameter that can be used to evaluate the good or poor quality of the brightness and contrast image and is associated with the gray scale distribution of the brightness and contrast image.

In an embodiment, obtaining the gray scale distribution of the brightness and contrast image includes: obtaining a normal distribution of the number of pixel points corresponding to each gray scale in the brightness and contrast image; calculating the number of pixel points corresponding to each gray scale within a preset number of sigmas o in the normal distribution to obtain the gray scale distribution of the brightness and contrast image. Obtaining a gray scale distribution evaluation value of the brightness and contrast image based on the gray scale distribution of the brightness and contrast image includes: determining whether one gray scale is qualified based on the number of pixel points corresponding to the one gray scale within the preset number of o in the normal distribution and the number of pixel points corresponding to the one gray scale in the preset standard gray scale distribution; calculating the pass rate of all the gray scales within the preset number of o in the normal distribution, as the gray scale distribution evaluation value of the brightness and contrast image. The gray scale distribution evaluation value obtained in this way is helpful for accurately determining the image quality of the brightness and contrast image in the subsequent steps.

In detail, determining whether one gray scale is qualified based on the number of pixel points corresponding to the one gray scale within the preset number of o in the normal distribution and the number of pixel points corresponding to the one gray scale in the preset standard gray scale distribution includes: calculating a ratio of the number of pixel points corresponding to the one gray scale within the preset number of o in the normal distribution to the number of pixel points corresponding to the one gray scale in the preset standard gray scale distribution; making a difference value between the obtained ratio and 100%; comparing the obtained difference value and the preset threshold value; when the obtained difference value is smaller than the preset threshold value, it is determined that the gray scale is qualified, and when the obtained difference value is greater than or equal to the preset threshold value, it is determined that the gray scale is unqualified. By comparing the actual gray scale distribution obtained with the standard gray scale distribution, whether each gray scale is qualified can be determined accurately.

Exemplarily, the preset threshold is 5%, that is, when a difference value between a ratio of the number of pixel points corresponding to the one gray scale within the preset number of sigmas in the normal distribution to the number of pixel points corresponding to the one gray scale in the standard gray scale distribution and 100% is less than 5%, it is determined that the gray scale is qualified. When a difference value between a ratio of the number of pixel points corresponding to the one gray scale within the preset number of o in the normal distribution to the number of pixel points corresponding to the one gray scale in the standard gray scale distribution and 100% is greater than or equal to 5%, it is determined that the gray scale is unqualified.

In an embodiment, the preset number of σ is 1 to 2σ, which already have a sufficiently large number of samples, a relatively accurate gray scale distribution evaluation value can be obtained, and unnecessary calculations can be reduced, thereby improving the calculation efficiency of the gray scale distribution evaluation value, so as to improve the efficiency of the image quality detection. In detail, the preset number of σ is, for example, 1σ, 1.5σ, 2σ, etc. Of course, the preset number of σ may also be more than 2σ.

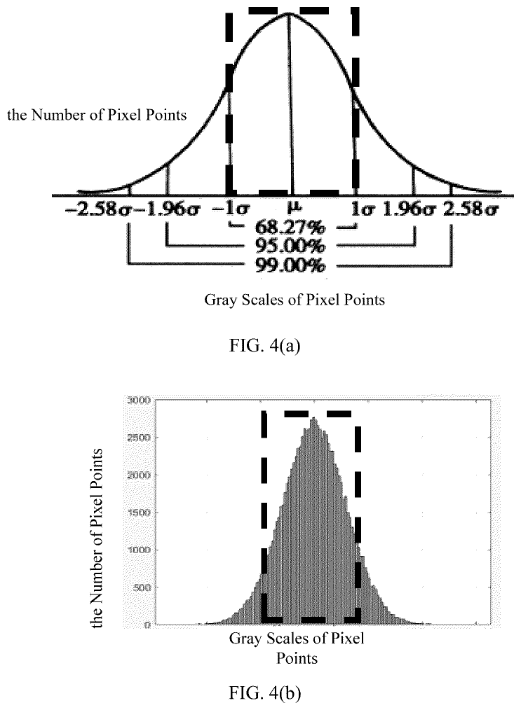

Exemplarily, (a) in FIG. 4 is a schematic diagram of a gray scale distribution of the brightness and contrast image obtained in step S210, and (b) in FIG. 4 is a schematic diagram of a standard gray scale distribution. The gray scale within the preset number of σ is, for example, 110 gray scales to 170 gray scales, and, in step S220, a difference value between a ratio of the number of pixel points corresponding to 110 gray scales in (a) in FIG. 4 to the number of pixel points corresponding to 110 gray scales in (b) in FIG. 4 and 100% is calculated, when the difference value is less than 5%, the 110 gray scales are determined to be qualified, otherwise, the 110 gray scales are determined to be unqualified; the same is true for the other gray scales. After determining whether all gray scales are qualified, the total number of qualified gray scales from 110 gray scales to 170 gray scales is divided by the total number of all gray scales from 110 gray scales to 170 gray scales, that is, the pass rate of all gray scales within the preset number of o can be obtained, that is, the gray scale distribution evaluation value of the brightness and contrast image can be obtained.

It is to be noted that taking the pass rate of all gray scales within the preset number of o in the normal distribution as the gray scale distribution evaluation value of the brightness and contrast image is only one embodiment of the present application, and in other embodiments, the gray scale distribution evaluation value may also be calculated in other ways.

Step S230, determining whether the gray scale distribution evaluation value of the brightness and contrast image meets the preset condition, and when the gray scale distribution evaluation value of the brightness and contrast image fails to meet the preset condition, the defect detection stopping step, that is, step S240, is entered.

In an embodiment, determining whether the gray scale distribution evaluation value of the brightness and contrast image meets the preset condition includes: determining whether the gray scale distribution evaluation value of the brightness and contrast image is greater than the preset threshold, when the gray scale distribution evaluation value of the brightness and contrast image is greater than the preset threshold, the gray scale distribution evaluation value meets the preset condition; and when the gray scale distribution evaluation value of the brightness and contrast image is smaller or equal to the preset threshold, the gray scale distribution evaluation value fails to meet the preset condition.

Exemplarily, the preset threshold is 95%, that is, when the pass rate of all gray scales within the preset number of o is greater than 95%, the gray scale distribution evaluation value meets the preset condition, the image quality of the brightness and contrast image is determined to be good. When the pass rate of all gray scales within the preset number of o is less than or equal to 95%, the gray scale distribution evaluation value fails to meet the preset condition, the image quality of the brightness and contrast image is determined to be poor, and the step S240 is entered.

Step S240, stopping to detect the defect of the to-be-detected wafer.

When the image quality of the brightness and contrast image is determined to be poor, the defect detection stopping step is directly entered, to stop the subsequent defect detection procedure of the to-be-detected wafer, thereby avoiding meaningless execution steps, and improving the effective utilization rate of the EBI.

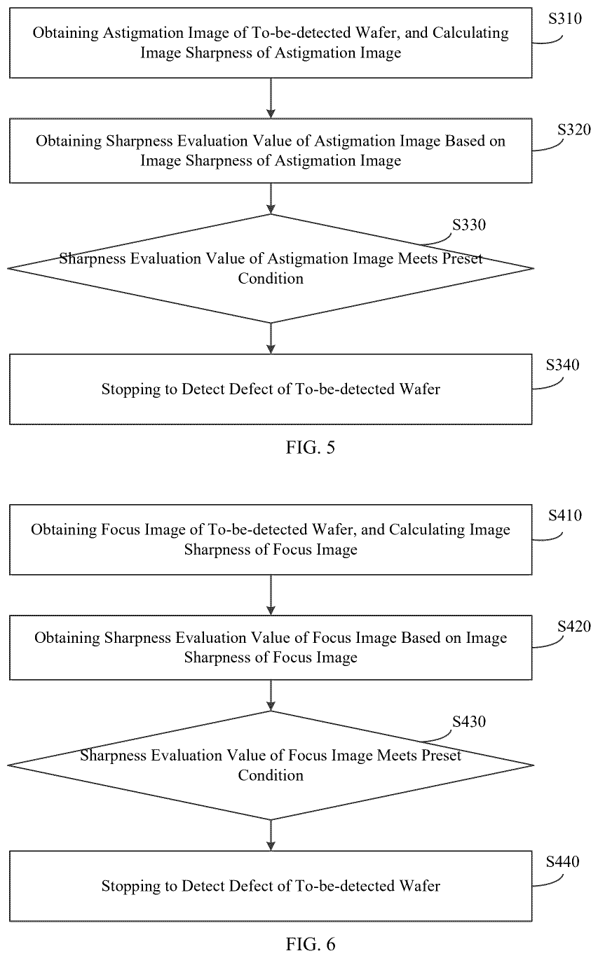

In an embodiment, when step S230 determines that the gray scale distribution evaluation value of the brightness and contrast image meets the preset condition, an astigmation image quality detection step is further performed, as shown in FIG. 5. The astigmation image quality detection step includes an astigmation image acquisition and sharpness calculation step, a sharpness evaluation value acquisition step, and an astigmation image quality determination step, corresponding to the following steps S310 to S330, respectively, which are described in detail below:

Step S310, obtaining an astigmation image of the to-be-detected wafer, and calculating an image sharpness of the astigmation image.

In an embodiment, obtaining the astigmation image of the to-be-detected wafer includes: using the electron-beam to scan a wafer region that is located located outside the target defect detection region, has a distance from the target defect detection region less than a third preset distance, and is not the defect detection region, to obtain the astigmation image of the wafer region.

The third preset distance is a preset distance sufficiently close to the target defect detection region, so that the astigmation image is an image of a region adjacent to the target defect detection region, to avoid that the astigmation image obtained cannot accurately represent the image quality of the target defect detection region due to subtle errors among different regions of the to-be-detected wafer.

In an embodiment, the image sharpness of the astigmation image is calculated based on a formula

$$P = \frac{{\sum }_{i = 1}^{m \times n} {\sum }_{a = 1}^{8} \vert df / dx \vert}{m \times n} ,$$

P is the image sharpness of the astigmation image, m and n are a length and a width of the astigmation image, respectively, and df is a magnitude of gray scale change of a pixel point of the astigmation image, dx is a distance increment between pixel points of the astigmation image, i is a pixel point of the astigmation image, and a is a neighbor point of the pixel point. That is, the gray scales of 8 neighbor points of each pixel point in the astigmation image are taken to be subtracted with the gray scales of the pixel point one by one, respectively, and it firstly solves the weighted sum of 8 gray scale difference values df obtained after subtracting the gray scales of 8 neighbor points with the gray scales of the pixel point respectively. The weight depends on the distance dx between the neighbor points and the pixel point, and the closer the neighbor point to the pixel point, the bigger the weight of the neighbor point, and the further the neighbor point away from the pixel point, the smaller the weight of the neighbor point. For example, a weight of the gray scale difference value between the gray scale of 45° and the gray scale of 135° is equal to a weight obtained by multiplying the weight of the gray scale difference value between the gray scale of 0° and the gray scale of 90° by 1/\sqrt{2}; and then the values of all pixel points are summed up and divided by the total number m×n of pixel points of the astigmation image, to obtain the image sharpness of the astigmation image P. The formula can be regarded as a statistic for the diffusion degree of gray scales around each pixel point of the astigmation image, that is, the more intense the diffusion is, the larger the value is, and the sharper the image is.

In this embodiment, the gray scale distribution of the image is reflected by the sum of gray scale difference values of the 8 neighbor points of the astigmation image, which is not susceptible to fluctuations in parameters caused by factors such as noise, such that accurate image sharpness calculation results can be obtained. Of course, in other embodiments, the image sharpness of the astigmation image can also be calculated in other ways.

Step S320, obtaining a sharpness evaluation value of the astigmation image based on the image sharpness of the astigmation image.

In an embodiment, the sharpness evaluation value of the astigmation image is obtained based on the image sharpness of the astigmation image, that is, the sharpness evaluation value of the astigmation image is obtained by calculating a sharpness difference value between the image sharpness of the astigmation image and a preset standard sharpness of the astigmation image, that is, a sharpness difference value between the image sharpness of the astigmation image and a preset standard sharpness of the astigmation image is taken as the sharpness evaluation value of the astigmation image. The method of calculating the sharpness evaluation value of the astigmation image is simple and can accurately evaluate the image quality of the astigmation image.

In an embodiment, the sharpness evaluation value of the astigmation image is obtained based on the image sharpness of the astigmation image, that is, the image sharpness of the astigmation image is used as the sharpness evaluation value of the astigmation image. When the sharpness evaluation value of the astigmation image is greater than or equal to the sum of the preset standard sharpness of the astigmation image and the second sharpness difference threshold, that is, the sharpness evaluation value of the astigmation image fails to meet the preset condition.

Of course, the present application is not limited to taking the sharpness difference value between the image sharpness of the astigmation image and the preset standard sharpness of the astigmation image, or the image sharpness of the astigmation image as the sharpness evaluation value of the astigmation image. In other embodiments, the sharpness evaluation value of the astigmation image can be determined in an arbitrary manner.

Step S330, determining whether the sharpness evaluation value of the astigmation image meets the preset condition, and when the sharpness evaluation value of the astigmation image fails to meet the preset condition, performing the defect detection stopping step, that is, the step S340, when the sharpness evaluation value of the astigmation image meets the preset condition, further performing the step of scanning, by the electron-beam, the target defect detection region of the to-be-detected wafer.

In an embodiment where the sharpness difference value between the image sharpness of the astigmation image and the preset standard sharpness of the astigmation image is used as the sharpness evaluation value of the astigmation image, when the sharpness evaluation value of the astigmation image is greater than or equal to the second sharpness difference threshold, that is, the sharpness evaluation value of the astigmation image fails to meet the preset condition, and the step S340 is entered. When the sharpness evaluation value of the astigmation image is less than the second sharpness difference threshold, that is, the sharpness evaluation value of the astigmation image meets the preset condition.

In an embodiment where the image sharpness of the astigmation image is used as the sharpness evaluation value of the astigmation image, when the sharpness evaluation value of the astigmation image is greater than or equal to a sum of the preset standard sharpness of the astigmation image and the second sharpness difference threshold, that is, the sharpness evaluation value of the astigmation image fails to meet the preset condition, the step S340 is entered. When the sharpness evaluation value of the astigmation image is smaller than the sum of the preset standard sharpness of the astigmation image and the second sharpness difference threshold, that is, the sharpness evaluation value of the astigmation image meets the preset condition.

Step S340, stopping to detect the defect of the to-be-detected wafer.

When it is determined that the image quality of the astigmation image is poor, it directly enters the defect detection stopping step to stop the subsequent defect detection procedure of the to-be-detected wafer, thereby avoiding meaningless execution steps and improving the effective utilization rate of the EBI.

It is to be noted that in some embodiments, when the step S230 determines that the gray scale distribution evaluation value of the brightness and contrast image meets the preset condition, it is possible to no longer execute the astigmation image quality detection step, but to directly perform the step of scanning, by the electron-beam, the target defect detection region of the to-be-detected wafer and subsequent related steps. In some embodiments, it is also possible to perform only the astigmation image quality detection step without performing the brightness and contrast image quality detection step.

In some embodiments, before performing the wafer defect detection step, a focus image quality detection step is performed, as shown in FIG. 6, the focus image quality detection step includes a focus image acquisition and sharpness calculation step, a sharpness evaluation value acquisition step, and a focus image quality determination step, corresponding to the following steps S410 to S430, respectively, which are described in detail below:

Step S410, obtaining a focus image of the to-be-detected wafer, and calculating an image sharpness of the focus image.

In an embodiment, obtaining the focus image of the to-be-detected wafer includes: using an electron-beam to scan a wafer region that is located located outside the target defect detection region, has a distance from the target defect detection region less than a fourth preset distance, and is not the defect detection region, to obtain the focus image of the wafer region.

The third preset distance is a preset distance sufficiently close to the target defect detection region, so that the focus image is an image of a region adjacent to the target defect detection region, to avoid that the focus image obtained cannot accurately represent the image quality of the target defect detection region due to subtle errors among different regions of the to-be-detected wafer.

In an embodiment, the image sharpness of the focus image is calculated based on a formula

$$P = \frac{{\sum }_{i = 1}^{m \times n} {\sum }_{a = 1}^{8} \vert df / dx \vert}{m \times n} ,$$

P is the image sharpness of the focus image, m and n are a length and a width of the focus image, respectively, and df is a magnitude of gray scale change of a pixel point of the focus image, dx is a distance increment between pixel points of the focus image, i is a pixel point of the focus image, and a is a neighbor point of the pixel point. That is, the gray scales of 8 neighbor points of each pixel point in the focus image are taken to be subtracted with the gray scales of the pixel point one by one, respectively, and it firstly solves the weighted sum of 8 gray scale difference values df obtained after subtracting the gray scales of 8 neighbor points with the gray scales of the pixel point respectively. The weight depends on the distance dx between the neighbor points and the pixel point, and the closer the neighbor point to the pixel point, the bigger the weight of the neighbor point, and the further the neighbor point away from the pixel point, the smaller the weight of the neighbor point. For example, a weight of the gray scale difference value between the gray scale of 45° and the gray scale of 135° is equal to a weight obtained by multiplying the weight of the gray scale difference value between the gray scale of 0° and the gray scale of 90° by 1/\sqrt{2}; and then the values of all pixel points are summed up and divided by the total number m×n of pixel points of the focus image, to obtain the image sharpness of the focus image P. The formula can be regarded as a statistic for the diffusion degree of gray scales around each pixel point of the focus image, that is, the more intense the diffusion is, the larger the value is, and the sharper the image is.

In this embodiment, the gray scale distribution of the image is reflected by the sum of gray scale difference values of the 8 neighbor points of the focus image, which is not susceptible to fluctuations in parameters caused by factors such as noise, such that accurate image sharpness calculation results can be obtained. Of course, in other embodiments, the image sharpness of the focus image can also be calculated in other ways.

Step S420, obtaining a sharpness evaluation value of the focus image based on the image sharpness of the focus image.

In an embodiment, the sharpness evaluation value of the focus image is obtained based on the image sharpness of the focus image, that is, the sharpness evaluation value of the wafer image is obtained by calculating a sharpness difference value between the image sharpness of the focus image and a preset standard sharpness of the focus image, that is, a sharpness difference value between the image sharpness of the focus image and a preset standard sharpness of the focus image is taken as the sharpness evaluation value of the focus image. The method of calculating the sharpness evaluation value of the focus image is simple and can accurately evaluate the image quality of the focus image.

In an embodiment, the sharpness evaluation value of the focus image is obtained based on the image sharpness of the focus image, that is, the image sharpness of the wafer image is used as the sharpness evaluation value of the focus image. When the sharpness evaluation value of the focus image is greater than or equal to the sum of the preset standard sharpness of the focus image and the first sharpness difference threshold, the sharpness evaluation value of the wafer image fails to meet the preset condition.

Of course, the present application is not limited to taking the sharpness difference value between the image sharpness of the focus image and the preset standard sharpness of the focus image, or the image sharpness of the focus image as the sharpness evaluation value of the focus image. In other embodiments, the sharpness evaluation value of the focus image can be determined in an arbitrary manner.

Step S430, determining whether the sharpness evaluation value of the focus image meets the preset condition, and when the sharpness evaluation value of the focus image fails to meet the preset condition, performing the defect detection stopping step, that is, step S440, and when the sharpness evaluation value of the focus image meets the preset condition, further performing the step of scanning, by the electron-beam, the target defect detection region of the to-be-detected wafer.

In an embodiment where the sharpness difference value between the image sharpness of the focus image and the preset standard sharpness of the focus image is used as the sharpness evaluation value of the focus image, when the sharpness evaluation value of the focus image is greater than or equal to the third sharpness difference threshold, that is, the sharpness evaluation value of the focus image fails to meet the preset condition, and the step S440 is entered. When the sharpness evaluation value of the focus image is less than the third sharpness difference threshold, that is, the sharpness evaluation value of the focus image meets the preset condition.

In an embodiment where the image sharpness of the focus image is used as the sharpness evaluation value of the focus image, when the sharpness evaluation value of the focus image is greater than or equal to a sum of the preset standard sharpness of the focus image and the third sharpness difference threshold, that is, the sharpness evaluation value of the focus image fails to meet the preset condition, the step S440 is entered. When the sharpness evaluation value of the focus image is smaller than the sum of the preset standard sharpness of the focus image and the third sharpness difference threshold, that is, the sharpness evaluation value of the focus image meets the preset condition.

Step S440, stopping to detect the defect of the to-be-detected wafer.

When it is determined that the image quality of the focus image is poor, it directly enters the defect detection stopping step to stop the subsequent defect detection procedure of the to-be-detected wafer, thereby avoiding meaningless execution steps and improving the effective utilization rate of the EBI.

In an embodiment, when step S430 determines that the sharpness evaluation value of the focus image meets the preset condition, a brightness and contrast image quality detection step is further performed, the brightness and contrast image quality detection step is described with specific reference to the above steps S210 to S230. When step S230 determines that the gray scale distribution evaluation value of the brightness and contrast image meets the preset condition, the astigmation image quality detection step is further performed, the astigmation image quality detection step is described with specific reference to the above steps S310 to S330. When the step S330 determines that the sharpness evaluation value of the astigmation image meets the preset condition, the step of scanning, by the electron-beam, the target defect detection region of the to-be-detected wafer is further performed. When the step S330 determines that the sharpness evaluation value of the astigmation image fails to meet the preset condition, the step of stopping to detect the defect of the to-be-detected wafer is performed.

Focus, brightness and contrast, and astigmation are three important evaluation indexes in the electron-beam scanning image, and the quality of the focus image, the quality of the brightness and contrast image, and the quality of the astigmation image are determined sequentially. When any of the indexes is bad, the defect of the to-be-detected wafer is stopped to be detected, and the step of scanning, by the electron-beam, the target defect detection region of the to-be-detected wafer is performed only when the three indexes are good, thereby avoiding meaningless execution steps at the greatest extent and improving the effective utilization rate of the EBI.

It is to be noted that in some embodiments, when the step S430 determines that the sharpness evaluation value of the focus image meets the preset condition, one or both of the brightness and contrast image quality detection step, the astigmation image quality detection step may no longer be executed. In some embodiments, the order of execution of the focus image quality detection step, the brightness and contrast image quality detection step, and the astigmation image quality detection step may also be switched.

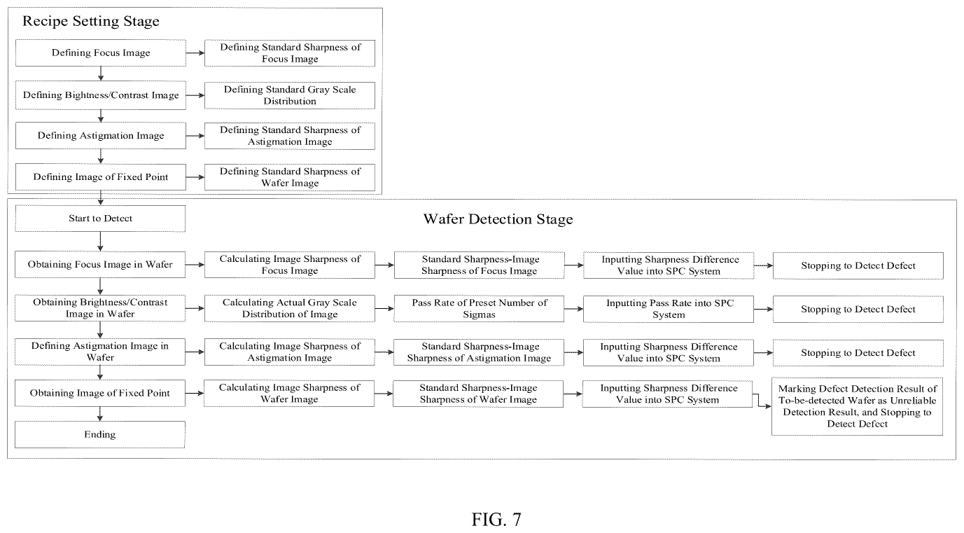

FIG. 7 is an overall flowchart of wafer defect detection of an embodiment of the present application, as shown in FIG. 7. The wafer defect detection includes a recipe setting stage and a wafer detection stage. In the recipe setting stage, a focus image, a brightness and contrast image, an astigmation image, and a wafer image are sequentially defined. A standard sharpness of the focus image, a standard gray scale distribution of the brightness and contrast image, a standard sharpness of the astigmation image, and a standard sharpness of the wafer image are defined. In the wafer detection stage, a focus image of the to-be-detected wafer is first obtained, the image sharpness of the focus image is calculated, and a sharpness difference value between the image sharpness of the focus image and the standard sharpness of the focus image is calculated, and the sharpness difference value is input into the SPC system, which determines whether the sharpness difference value is less than the third sharpness difference threshold. If not, the defect of the to-be-detected wafer is stopped to be detected; and if yes, the brightness and contrast image of the to-be-detected wafer is further obtained, and the gray scale distribution of the brightness and contrast image is calculated, and the pass rate of all gray scales within the preset number of o in the gray scale distribution is calculated, and the pass rate is input into the SPC system, which determines whether the pass rate is greater than the preset threshold; if yes, the defect of the to-be-detected wafer is stopped to be detected; if not, the astigmation image of the to-be-detected wafer is obtained. The image sharpness of the astigmation image is calculated, and the sharpness difference value between the image sharpness of the astigmation image and the standard sharpness of the astigmation image is calculated, the sharpness difference value is input into the SPC system, which determines whether the sharpness difference value is less than the second sharpness difference threshold, if not, the defect of the to-be-detected wafer is stopped to be detected; if yes, the wafer defect detection step is entered to scan by the electron-beam the target defect detection region of the to-be-detected wafer. After the scanning is completed, the wafer image of the to-be-detected wafer is obtained by obtaining image of a fixed point, and the image sharpness of the wafer image is calculated, and the sharpness difference value between the image sharpness of the wafer image and the standard sharpness of the wafer image is calculated, and the sharpness difference value is input into the SPC system, which determines whether the sharpness difference value is less than the first sharpness difference threshold, and if not, the defect of the to-be-detected wafer is stopped to be detected and the defect detection result of the to-be-detected wafer is marked as the unreliable detection result.

In the embodiment shown in FIG. 7, the quality of the focus image, the quality of the brightness and contrast image, and the quality of the astigmation image are determined sequentially. When any of the indexes is bad, the defect of the to-be-detected wafer is stopped to be detected, and when all three indexes are good, that is, it is confirmed that there is no failure of the EBI, and that there is no problem with the to-be-detected wafer (e.g., the to-be-detected wafer is not placed in a good position), then the step of scanning, by the electron-beam, the target defect detection region of the to-be-detected wafer is performed, thereby avoiding unreliable subsequent defect detection results due to EBI failures, the to-be-detected wafer not being placed in a good position, and avoiding meaningless execution steps at the greatest extent possible and improving the effective utilization of the EBI. The EBI may be faulty during the detection phase, and after the scanning is completed, the image quality is checked twice, thereby avoiding the inaccuracy of defect detection results due to the poor quality of images caused by problems with the EBI or the wafer during the scanning phase, and improving the final results of defect detection. Moreover, the present application performs image quality detection for the actual to-be-detected wafer, and the accuracy of image quality monitoring is high.

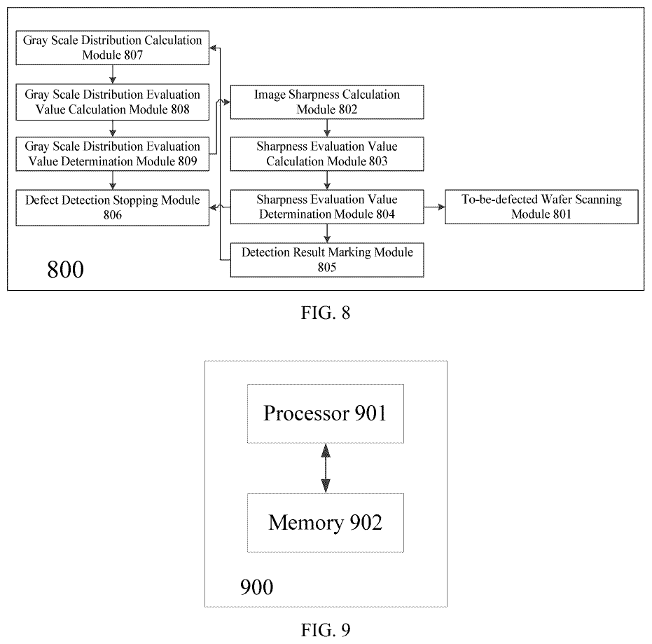

Referring next to FIG. 8, the present embodiment provides a wafer defect detection device 800, which mainly includes a to-be-defected wafer scanning module 801, an image sharpness calculation module 802, a sharpness evaluation value calculation module 803, a sharpness evaluation value determination module 804, and a detection result marking module 805.

The to-be-detected wafer scanning module 801 is configured for scanning, by an electron-beam, a target defect detection region of a to-be-detected wafer to detect a defect of the target defect detection region, the to-be-detected wafer has one or more defect detection regions.

The image sharpness calculation module 802 is configured for obtaining a wafer image of the to-be-detected wafer, and calculating an image sharpness of the wafer image.

In an embodiment, the image sharpness calculation module 802 is configured for calculating the image sharpness of the wafer image based on a formula

$$P = \frac{{\sum }_{i = 1}^{m \times n} {\sum }_{a = 1}^{8} \vert df / dx \vert}{m \times n} ,$$

where P is the image sharpness of the wafer image, m and n are a length and a width of the wafer image, respectively, and df is a magnitude of gray scale change of a pixel point of the wafer image, dx is a distance increment between pixel points of the wafer image, i is a pixel point of the wafer image, and a is a neighbor point of the pixel point.

In an embodiment, the wafer image is an image of a wafer region that is located outside the target defect detection region on the to-be-detected wafer, has a distance from the target defect detection region less than a first preset distance, and is not scanned by the electron-beam.

The sharpness evaluation value calculation module 803 is configured for obtaining a sharpness evaluation value of the wafer image based on the image sharpness of the wafer image.

The sharpness evaluation value determination module 804 is configured for determining whether the sharpness evaluation value of the wafer image meets a preset condition. The detection result marking module 805 is configured for marking a defect detection result of the to-be-detected wafer as an unreliable detection result when the sharpness evaluation value of the wafer image fails to meet the preset condition.

In an embodiment, the sharpness evaluation value calculation module 803 is configured for calculating a sharpness difference value between the image sharpness of the wafer image and a preset standard sharpness of the wafer image, to obtain the sharpness evaluation value of the wafer image. The sharpness evaluation value of the wafer image fails to meet the preset condition when the sharpness evaluation value of the wafer image is greater than or equal to a first sharpness difference threshold.

In an embodiment, the sharpness evaluation value calculation module 803 is configured for outputting the sharpness evaluation value of the wafer image to the SPC system, and the detection result marking module 805 is part of the SPC system.

In an embodiment, the wafer defect detection device 800 further includes a defect detection stopping module 806, the defect detection stopping module 806 is configured for stopping to detect the defect of the to-be-detected wafer when the sharpness evaluation value of the wafer image fails to meet the preset condition.

In an embodiment, the wafer defect detection device 800 further includes a gray scale distribution calculation module 807, a gray scale distribution evaluation value calculation module 808, and a gray scale distribution evaluation value determination module 809. The gray scale distribution calculation module 807 is configured for obtaining a brightness and contrast image of the to-be-detected wafer, and obtaining a gray scale distribution of the brightness and contrast image; the gray scale distribution evaluation value calculation module 808 is configured for obtaining a gray scale distribution evaluation value of the brightness and contrast image based on the gray scale distribution of the brightness and contrast image; the gray scale distribution evaluation value determination module 809 is configured for determining whether the gray scale distribution evaluation value meets the preset condition; the defect detection stopping module 806 is configured for stopping to detect the defect of the to-be-detected wafer when the gray scale distribution evaluation value of the brightness and contrast image fails to meet the preset condition.

In an embodiment, the gray scale distribution calculation module 807 is configured for obtaining a normal distribution of a number of pixel points corresponding to each gray scale in the brightness and contrast image; and calculating a number of pixel points corresponding to each gray scale within a preset number of sigmas in the normal distribution, to obtain the gray scale distribution of the brightness and contrast image; and the gray scale distribution evaluation value calculation module 808 is configured for determining whether one gray scale is qualified based on the number of pixel points corresponding to the one gray scale within the preset number of sigmas in the normal distribution and a number of pixel points corresponding to the one gray scale in a preset standard gray scale distribution; and calculating a pass rate of all gray scales within the preset number of sigmas in the normal distribution as the gray scale distribution evaluation value of the brightness and contrast image.

In an embodiment, the preset number of sigmas is 1 to 2 sigmas.

In an embodiment, the gray scale distribution evaluation value calculation module 808 is configured for determining that the one gray scale is qualified when a difference value between a ratio of the number of pixel points corresponding to the one gray scale within the preset number of sigmas in the normal distribution to the number of pixel points corresponding to the one gray scale in the standard gray scale distribution and 90% is less than 5%. The gray scale distribution evaluation value fails to meet the preset condition when a pass rate of all gray scales is less than or equal to 95%; and the gray scale distribution evaluation value meets the preset condition when the pass rate of all gray scales is greater than 95%.

In an embodiment, the image sharpness calculation module 802 is also configured for obtaining an astigmation image of the to-be-detected wafer, and calculating an image sharpness of the astigmation image; the sharpness evaluation value calculation module 803 is also configured for obtaining a sharpness evaluation value of the astigmation image based on the image sharpness of the astigmation image; the sharpness evaluation value determination module 804 is configured for determining whether the sharpness evaluation value of the astigmation image meets the preset condition; the defect detection stopping module 806 is configured for stopping to detect the defect of the to-be-detected wafer when the sharpness evaluation value of the astigmation image fails to meet the preset condition; the to-be-detected wafer scanning module 801 is configured for performing the step of scanning, by the electron-beam, the target defect detection region of the to-be-detected wafer when the sharpness evaluation value of the astigmation image meets the preset condition.

In an embodiment, the sharpness evaluation value calculation module 803 is configured for calculating a sharpness difference value between the image sharpness of the astigmation image and a preset standard sharpness of the astigmation image, to obtain the sharpness evaluation value of the astigmation image. The sharpness evaluation value of the astigmation image fails to meet the preset condition when the sharpness evaluation value of the astigmation image is greater than or equal to a second sharpness difference threshold; and the sharpness evaluation value of the astigmation image meets the preset condition when the sharpness evaluation value of the astigmation image is less than the second sharpness difference threshold.

In an embodiment, the image sharpness calculation module 802 is also configured for obtaining an astigmation image of the to-be-detected wafer, and calculating an image sharpness of the astigmation image; the sharpness evaluation value calculation module 803 is also configured for obtaining a sharpness evaluation value of the astigmation image based on the image sharpness of the astigmation image; the sharpness evaluation value determination module 804 is configured for determining whether the sharpness evaluation value of the astigmation image meets the preset condition; the defect detection stopping module 806 is configured for stopping to detect the defect of the to-be-detected wafer when the sharpness evaluation value of the astigmation image fails to meet the preset condition.

In an embodiment, the sharpness evaluation value calculation module 803 is configured for calculating a sharpness difference value between the image sharpness of the focus image and a preset standard sharpness of the focus image, to obtain the sharpness evaluation value of the focus image. The sharpness evaluation value of the focus image fails to meet the preset condition when the sharpness evaluation value of the focus image is greater than or equal to a third sharpness difference threshold.

The implementation process of the functions and roles of the various modules in the above wafer defect detection device 800 is specifically detailed in the implementation process of the corresponding steps in the above wafer defect detection method, and will not be repeated herein.

Referring to FIG. 9, the present embodiment provides an electron-beam scanning device 900, the electron-beam scanning device 900 includes one or more processors 901 and a memory 902, the memory 902 is used for storing one or more programs, which, when executed by the one or more processors 901, causes the electron-beam scanning device 900 to implement the wafer defect detection method of the present application.

It is noted that the electron-beam scanning device 900 may be loaded with the aforementioned SPC system.

The present application redesigns the image quality monitoring system for EBI, pre-detects the sharpness and gray scale distribution of the image, and detects secondary after the scanning is completed, and marks the defect detection results of the to-be-detected wafer with a poor quality of the wafer image as the unreliable detection result, for distinguishing the defect detection results of the to-be-detected wafer that has a good quality of the wafer image, thereby improving reliability of the defect detection result of the each to-be-detected wafer. Moreover, the defect detection procedure for the to-be-detected wafer that has a poor quality of the wafer image is stopped in a timely manner to avoid meaningless execution steps and to improve the effective utilization rate of the EBI.

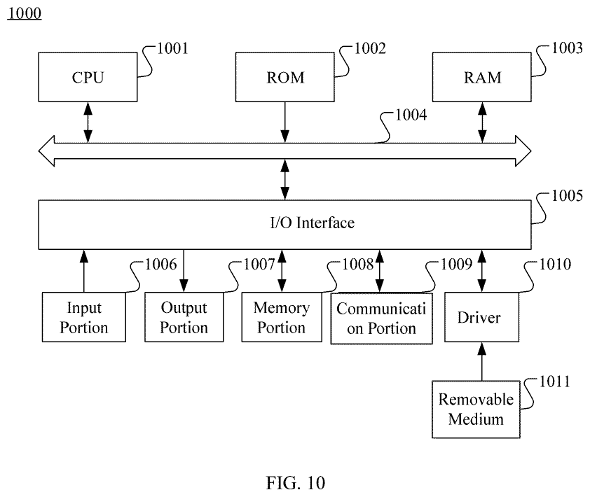

FIG. 10 is a block diagram of a computer system structure for implementing some embodiments of the present application, and it is to be noted that the computer system in FIG. 10 is only an example, and should not bring about any limitation on the functions and scope of use of the embodiments of the present application.

As shown in FIG. 10, the computer system 1000 includes a central processing unit (CPU) 1001 that can perform various appropriate actions and processes, such as performing the wafer defect detection method in the above embodiment, based on programs stored in Read-Only Memory (ROM) 1002 or programs in the random-access memory (RAM) 1003 loaded from the memory portion 1008. Various programs and data required for system operation are also stored in the RAM 1003. The CPU 1001, the ROM 1002, and the RAM 1003 are connected to each other via the bus 1004. The Input/Output (I/O) interface 1005 is also connected to the bus 1004.

The following components connected to the I/O interface 1005 include: an input portion 1006 including a keyboard, a mouse, etc.; an output portion 1007 including, for example, a Cathode Ray Tube (CRT), a Liquid Crystal Display (LCD), etc., and a speaker, etc.; The memory portion 1008 including a hard disc, etc.; and a communication portion 1009 including a network interface card such as a Local region Network (LAN) card, etc. The communication portion 1009 performs communication processing via a network such as the Internet. The drive 1010 is also connected to the I/O interface 1005 as needed. The removable medium 1011, such as disks, optical discs, magnetic discs, semiconductor memories, etc., are mounted on the drive 1010 as needed so that a computer program read therefrom is mounted into the memory portion 1008 as needed.

In particular, according to embodiments of the present application, the process described above with reference to the flowchart may be implemented as a computer software program. For example, embodiments of the present application include a computer program product including a computer program carried on a computer-readable medium, the computer program includes a computer program for performing all or some of the steps shown in the flowchart in the wafer defect detection method. In such an embodiment, the computer program may be downloaded and installed from a network via a communication portion 1009, and/or installed from a detachable medium 1011. When the computer program is executed by the central processing unit (CPU) 1001, various functions defined in the system of the present application are performed.

It is noted that the computer-readable medium shown in embodiments of the present application may be a computer-readable signal medium or a computer-readable storage medium or any combination thereof. The computer-readable storage medium may, for example, be—but is not limited to—a system, an apparatus, or a device of electricity, magnetism, light, electromagnetism, infrared, or semiconductors, or any combination of the above. More specific examples of computer-readable storage medium may include, but are not limited to: an electrical connection having one or more wires, a portable computer disk, a hard drive, a random access memory (RAM), a read-only memory (ROM), an Erasable Programmable Read Only Memory (EPROM), a flash memory, an optical fibre, a portable compact disk Read-Only Memory (CD-ROM), an optical storage devices, a magnetic storage devices, or any suitable combination of the foregoing. In the present application, a computer-readable storage medium may be any tangible medium containing or storing a program that may be used by or in combination with an instruction execution system, apparatus or device. And in this application, the computer-readable signal medium may include a data signal propagated in baseband or as part of a carrier carrying a computer-readable computer program. Such propagated data signals may take a variety of forms, including, but not limited to, electromagnetic signals, optical signals, or any suitable combination of the foregoing. The computer-readable signal medium may also be any computer-readable medium other than the computer-readable storage medium that sends, propagates or transmits a program for use by, or in conjunction with, an instruction execution system, apparatus or device. The computer program contained on the computer-readable medium may be transmitted using any suitable medium, including, but not limited to: wireless, wired, etc., or any suitable combination of the foregoing.

The flowcharts and block diagrams in the accompanying drawings illustrate the architecture, functionality, and operation of systems, methods, and computer program products that may be implemented in accordance with various embodiments of the present application. Each box in the flowcharts or block diagrams may represent a module, a program segment, or a portion of code, and the module, program segment, or portion of code contains one or more executable instructions for carrying out a specified logical function. It should also be noted that in some implementations as replacements, the functions indicated in the boxes may also occur in a different order from that indicated in the accompanying drawings. For example, two consecutively represented boxes can actually be executed substantially in parallel, and they can sometimes be executed in reverse order, depending on the function involved. It should also be noted that each box in a block diagram or flowchart, and combinations of boxes in a block diagram or flowchart, may be implemented with a dedicated hardware-based system that performs the specified function or operation, or may be implemented with a combination of dedicated hardware and computer instructions.

The units described as being involved in the embodiments of the present application may be implemented by way of software or hardware, and the described units may also be provided in a processor. The names of the units do not constitute a limitation of the unit itself in a certain case.

As another aspect, the present application also provides a computer-readable medium, which computer-readable medium may be contained in the electron-beam scanning device described in the above embodiment; or it may be separate and not assembled into such electron-beam scanning device. The computer-readable medium carries one or more programs which, when the one or more programs are executed by one such electron-beam scanning device, cause the electron-beam scanning device to implement the method in the above embodiment.

It should be noted that although a number of modules or units of the device for action execution are referred to in the detailed description above, this division is not mandatory. Indeed, according to embodiments of the present application, the features and functions of two or more modules or units described above may be specified in a single module or unit. Conversely, the features and functions of one module or unit described above may be further divided to be specified by more than one module or unit.

By the above description of the embodiments, it is readily understood by those skilled in the art that the embodiments described herein can be implemented by means of software or by means of software in combination with the necessary hardware. Thus, the technical solution according to the embodiments of the present application may be embodied in the form of a software product that may be stored in a non-volatile storage medium (which may be a CD-ROM, a USB flash drive, a removable hard drive, etc.) or on a network, and includes a number of instructions to cause a computing device (which may be a personal computer, a server, a touch terminal, or a network device, etc.) to perform the method according to the embodiments of the present application.

Other embodiments of the present application will readily come to mind to those skilled in the art upon consideration of the specification and practice of the invention disclosed herein. The present application is intended to cover any variations, uses, or adaptations of the present application that follow the general principles of the present application and that include means of common knowledge or practice in the art not disclosed herein. The specification and embodiments are to be regarded as exemplary only, and the true scope and spirit of the present application is indicated by the appended claims.

What is claimed is:

1. A wafer defect detection method, comprising:
scanning, by an electron-beam, a target defect detection region of a to-be-detected wafer to detect a defect of the target defect detection region, wherein the to-be-detected wafer has one or more defect detection regions;
obtaining a wafer image of the to-be-detected wafer, and calculating an image sharpness of the wafer image;
obtaining a sharpness evaluation value of the wafer image based on the image sharpness of the wafer image;
determining whether the sharpness evaluation value of the wafer image meets a preset condition; and
marking a defect detection result of the to-be-detected wafer as an unreliable detection result when the sharpness evaluation value of the wafer image fails to meet the preset condition.

2. The wafer defect detection method according to claim 1, wherein obtaining the sharpness evaluation value of the wafer image based on the image sharpness of the wafer image comprises:
calculating a sharpness difference value between the image sharpness of the wafer image and a preset standard sharpness of the wafer image, to obtain the sharpness evaluation value of the wafer image;
wherein the sharpness evaluation value of the wafer image fails to meet the preset condition when the sharpness evaluation value of the wafer image is greater than or equal to a first sharpness difference threshold.

3. The wafer defect detection method according to claim 1, wherein when the sharpness evaluation value of the wafer image fails to meet the preset condition, the defect of the to-be-detected wafer is stopped to be detected.

4. The wafer defect detection method according to claim 1, wherein after obtaining the sharpness evaluation value of the wafer image, the method further comprises:
outputting the sharpness evaluation value of the wafer image to a statistical process control system, to make the statistical process control system to mark the defect detection result of the to-be-detected wafer as the unreliable detection result when the sharpness evaluation value of the wafer image fails to meet the preset condition.

5. The wafer defect detection method according to claim 1, wherein calculating the image sharpness of the wafer image comprises:
calculating the image sharpness of the wafer image based on a formula
$$P = \frac{{\sum }_{i = 1}^{m \times n} {\sum }_{a = 1}^{8} \vert df / dx \vert}{m \times n} ,$$
wherein P is the image sharpness of the wafer image, m and n are a length and a width of the wafer image, respectively, and df is a magnitude of gray scale change of a pixel point of the wafer image, dx is a distance increment between pixel points of the wafer image, i is a pixel point of the wafer image, and a is a neighbor point of the pixel point.

6. The wafer defect detection method according to claim 1, wherein the wafer image is an image of a wafer region that is located outside the target defect detection region on the to-be-detected wafer, has a distance from the target defect detection region less than a first preset distance, and is not scanned by the electron-beam.

7. The wafer defect detection method according to claim 1, wherein before scanning, by the electron-beam, the target defect detection region of the to-be-detected wafer, the method further comprises:
obtaining a brightness and contrast image of the to-be-detected wafer, and obtaining a gray scale distribution of the brightness and contrast image;
obtaining a gray scale distribution evaluation value of the brightness and contrast image based on the gray scale distribution of the brightness and contrast image;
determining whether the gray scale distribution evaluation value meets the preset condition; and
stopping to detect the defect of the to-be-detected wafer when the gray scale distribution evaluation value fails to meet the preset condition.

8. The wafer defect detection method according to claim 7, wherein obtaining the gray scale distribution of the brightness and contrast image comprises:
obtaining a normal distribution of a number of pixel points corresponding to each gray scale in the brightness and contrast image; and
calculating a number of pixel points corresponding to each gray scale within a preset number of sigmas in the normal distribution, to obtain the gray scale distribution of the brightness and contrast image;
wherein obtaining the gray scale distribution evaluation value of the brightness and contrast image based on the gray scale distribution of the brightness and contrast image comprises:
determining whether one gray scale is qualified based on the number of pixel points corresponding to the one gray scale within the preset number of sigmas in the normal distribution and a number of pixel points corresponding to the one gray scale in a preset standard gray scale distribution; and
calculating a pass rate of all gray scales within the preset number of sigmas in the normal distribution as the gray scale distribution evaluation value of the brightness and contrast image.

9. The wafer defect detection method according to claim 8, wherein the preset number of sigmas is 1 to 2 sigmas.

10. The wafer defect detection method according to claim 8, wherein the one gray scale is determined to be qualified when a difference value between a ratio of the number of pixel points corresponding to the one gray scale within the preset number of sigmas in the normal distribution to the number of pixel points corresponding to the one gray scale in a standard gray scale distribution and 100% is less than 5%; and/or
the gray scale distribution evaluation value fails to meet the preset condition when a pass rate of all gray scales is less than or equal to 95%; and
the gray scale distribution evaluation value meets the preset condition when the pass rate of all gray scales is greater than 95%.

11. The wafer defect detection method according to claim 7, wherein when the gray scale distribution evaluation value meets the preset condition, the method further comprises:
obtaining an astigmation image of the to-be-detected wafer, and calculating an image sharpness of the astigmation image;
obtaining a sharpness evaluation value of the astigmation image based on the image sharpness of the astigmation image;
determining whether the sharpness evaluation value of the astigmation image meets the preset condition;
stopping to detect the defect of the to-be-detected wafer when the sharpness evaluation value of the astigmation image fails to meet the preset condition; and
performing a step of scanning, by the electron-beam, the target defect detection region of the to-be-detected wafer when the sharpness evaluation value of the astigmation image meets the preset condition.

12. The wafer defect detection method according to claim 11, wherein obtaining the sharpness evaluation value of the astigmation image based on the image sharpness of the astigmation image comprises:
calculating a sharpness difference value between the image sharpness of the astigmation image and a preset standard sharpness of the astigmation image, to obtain the sharpness evaluation value of the astigmation image;
wherein the sharpness evaluation value of the astigmation image fails to meet the preset condition when the sharpness evaluation value of the astigmation image is greater than or equal to a second sharpness difference threshold; and
the sharpness evaluation value of the astigmation image meets the preset condition when the sharpness evaluation value of the astigmation image is less than the second sharpness difference threshold.

13. The wafer defect detection method according to claim 1, wherein before scanning, by the electron-beam, the target defect detection region of the to-be-detected wafer, the method further comprises:
obtaining an astigmation image of the to-be-detected wafer, and calculating an image sharpness of the astigmation image;
obtaining a sharpness evaluation value of the astigmation image based on the image sharpness of the astigmation image;
determining whether the sharpness evaluation value of the astigmation image meets the preset condition; and
stopping to detect the defect of the to-be-detected wafer when the sharpness evaluation value of the astigmation image fails to meet the preset condition.

14. The wafer defect detection method according to claim 1, wherein before scanning, by the electron-beam, the target defect detection region of the to-be-detected wafer, the method further comprises:
obtaining a focus image of the to-be-detected wafer, and calculating an image sharpness of the focus image;
obtaining a sharpness evaluation value of the focus image based on the image sharpness of the focus image;
determining whether the sharpness evaluation value of the focus image meets the preset condition; and
stopping to detect the defect of the to-be-detected wafer when the sharpness evaluation value of the focus image fails to meet the preset condition.

15. The wafer defect detection method according to claim 14, wherein obtaining the sharpness evaluation value of the focus image based on the image sharpness of the focus image comprises:
calculating a sharpness difference value between the image sharpness of the focus image and a preset standard sharpness of the focus image, to obtain the sharpness evaluation value of the focus image;
wherein the sharpness evaluation value of the focus image fails to meet the preset condition when the sharpness evaluation value of the focus image is greater than or equal to a third sharpness difference threshold.

16. The wafer defect detection method according to claim 14, wherein when the sharpness evaluation value of the focus image meets the preset condition, the method further comprises:
obtaining a brightness and contrast image of the to-be-detected wafer, and obtaining a gray scale distribution of the brightness and contrast image;
obtaining a gray scale distribution evaluation value of the brightness and contrast image based on the gray scale distribution of the brightness and contrast image;
determining whether the gray scale distribution evaluation value meets the preset condition;
stopping to detect the defect of the to-be-detected wafer when the gray scale distribution evaluation value fails to meet the preset condition;
when the gray scale distribution evaluation value meets the preset condition, obtaining an astigmation image of the to-be-detected wafer, and calculating an image sharpness of the astigmation image;
obtaining a sharpness evaluation value of the astigmation image based on the image sharpness of the astigmation image;
determining whether the sharpness evaluation value of the astigmation image meets the preset condition;
stopping to detect the defect of the to-be-detected wafer when the sharpness evaluation value of the astigmation image fails to meet the preset condition; and
performing a step of scanning, by the electron-beam, the target defect detection region of the to-be-detected wafer when the sharpness evaluation value of the astigmation image meets the preset condition.

17. A wafer defect detection device, comprising:
a to-be-detected wafer scanning module, configured for scanning, by an electron-beam, a target defect detection region of a to-be-detected wafer to detect a defect of the target defect detection region, wherein the to-be-detected wafer has one or more defect detection regions;
an image sharpness calculation module, configured for obtaining a wafer image of the to-be-detected wafer, and calculating an image sharpness of the wafer image;
a sharpness evaluation value calculation module, configured for obtaining a sharpness evaluation value of the wafer image based on the image sharpness of the wafer image;
a sharpness evaluation value determination module, configured for determining whether the sharpness evaluation value of the wafer image meets a preset condition; and
a detection result marking module, configured for marking a defect detection result of the to-be-detected wafer as an unreliable detection result when the sharpness evaluation value of the wafer image fails to meet the preset condition.

18. An electron-beam scanning device, comprising:
one or more processors; and
a memory, for storing one or more computer programs;
wherein the one or more computer programs, when executed by the one or more processors, cause the one or more processors to implement the wafer defect detection method according to claim 1.

19. A non-transient computer-readable storage medium, on which computer-readable instructions are stored, the computer-readable instructions when executed by a processor of a computer, cause the computer to implement the wafer defect detection method according to claim 1.
